(19) United States
(12) Patent Application Publication
(10) Pub. No.: US 2025/0057361 A1
(43) Pub. Date: Feb. 20, 2025

(54) INGREDIENT DROPPER AND ARRANGEMENTS THEREOF

(71) Applicant: KENWOOD LIMITED, Havant, Hampshire (GB)

(72) Inventors: Sean SWEENEY, Havant (GB); Samuele MEDA, Havant (GB)

(21) Appl. No.: 18/719,485

(22) PCT Filed: Dec. 20, 2022
(86) PCT No.: PCT/GB2022/053308

§ 371 Date: Jun. 13, 2024

(30) Foreign Application Priority Data
Jan. 5, 2022 (GB) 2200067.3
Jan. 7, 2022 (LU) LU102899

(51) Int. Cl. A47J 43/07; A47J 43/044

(52) U.S. Cl. CPC A47J 43/0705; A47J 43/044; A47J 2043/04454

(57) ABSTRACT

A lid for a container is disclosed. The lid includes an ingredient dropper, and the lid is adapted to transmit vibration to the ingredient dropper. An ingredient dropper is also disclosed. The ingredient dropper comprises: an aperture for dropping foodstuff into a container, and a baffle for baffling a flow of foodstuff between the aperture and the container, wherein the baffle extends across at least part of the aperture.

### FIELD

The present invention relates to an ingredient dropper for a food processing appliance. The present invention also extends to a lid, container, and food processor device including an ingredient dropper.

### BACKGROUND

An ingredient dropper is a container into which a food (e.g. sugar) and/or beverage (e.g. lemon juice) ingredient can be placed such that it will slowly drip or drop out of a hole at the bottom of the container. The hole is designed to reduce the flow of ingredients to a relatively small amount, and preferably to single drops. The small size of the hole allows ingredients to collect in a reservoir above it. Ingredient droppers can be integrated into the lids of food processing appliances such that an ingredient such as, for example, oil (e.g., a plant-based oil such as olive oil, or a juice such as lemon juice) can be slowly added to food through a hole in the lid during processing of the food. Slow addition of the ingredient prevents e.g., clumping, splitting, or curdling whilst making e.g., mayonnaise. It can also allow the user to more precisely control addition of the ingredient.

Two problems exist in the field of ingredient droppers. The first is that the flow of the ingredient can become irregular, particularly as the ingredient container becomes less full, due to a lower pressure driving the ingredient through the lower hole, and obstruction of the lower hole by e.g., pips and other detritus entrained in the ingredient. The second is that ingredients being processed below the ingredient dropper may be deflected up through the lower hole, potentially blocking it.

The present invention aims to at least partially ameliorate the above-described problems of the prior art.

### SUMMARY OF THE INVENTION

According to an aspect of the present invention, there is provided a lid for a container, the lid including an ingredient dropper, wherein the lid is adapted to transmit vibration to the ingredient dropper.

The ingredient dropper preferably comprises a reservoir for the ingredient communicating with an aperture at or adjacent a base of the reservoir arranged to reduce the flow of the ingredient out of the reservoir, preferably by being sized to cause or allow the ingredient to form droplets which drip or drop out of the reservoir, or to cause or allow the ingredient to form a thin stream.

Transmitting vibration to the ingredient dropper can provide a steady flow of foodstuff/ingredients from the ingredient dropper to the container, and can assist in clearing detritus obstructing this flow (e.g. detritus in an aperture of the ingredient dropper).

The ingredient dropper is preferably for dropping foodstuff into the container. ‘Dropping’ preferably connotes causing or allowing the foodstuff to fall in drops or droplets, or a thin stream.

The lid is preferably adapted to transmit vibration to the ingredient dropper from a vibration source.

The lid preferably includes an attachment portion (more preferably, for the vibration source) configured to connect directly to the vibration source. This can allow particularly efficient transmission of vibration from the vibration source to the ingredient dropper, as the lid (and preferably the ingredient dropper on the lid) are directly agitated/vibrated by the vibration source. Preferably, the ingredient dropper is arranged to abut the attachment portion and/or the attachment portion forms part of the ingredient dropper.

The lid is preferably adapted to support at least part of the weight of the vibration source, more preferably the lid is adapted to support the entire weight of the vibration source. This can increase the transmission of vibration from the vibration source to the lid.

The vibration source is preferably a motor unit, more preferably a motor unit for driving a tool within the container.

The lid is preferably adapted to house the vibration source, more preferably wherein the vibration source is arranged away from the container. This can facilitate transmission of vibration from the vibration source to the ingredient dropper on the lid, whilst reducing the transmission of vibration from the vibration source to the container. Preferably, (a cover portion of) the lid is adapted to attach to the container on one side, and to attach to the vibration source on a second, opposite, side. In other words, the vibration source and the container may be attachable to the lid on opposite sides of the (cover portion of the) lid. The vibration source and the container are preferably arranged on opposite sides of the (cover portion of the) lid. The lid is preferably removably attachable to the vibration source and the container.

The lid preferably further includes a/the vibration source. Preferably, the vibration source is releasably attachable to the lid or integral to the lid. Preferably, the vibration source is the vibration source as aforesaid and/or as described herein.

The lid is preferably adapted to receive drive for driving a tool within the container. Preferably, the lid is adapted to transmit vibration from the drive to the ingredient dropper. The drive may be a/the vibration source.

The vibration source is preferably operable to vibrate at a frequency at, or near, a natural frequency of vibration of the ingredient dropper.

The ingredient dropper is preferably adapted to receive vibration from the lid. The ingredient dropper is preferably adapted to receive vibration from a motor unit for driving a food processing tool in the container.

The motor unit may include a cable-outlet configured to act as a cable-wrap.

The lid preferably further comprises a damper for dampening transmission of vibration from the lid to the container. The damper preferably includes a container attachment portion, more preferably a skirt, for attaching the lid to the container.

The lid preferably further comprises a container attachment portion for attaching the lid to the container. The container attachment portion is preferably a skirt. The container attachment portion is preferably adapted to dampen transmission of vibration from the lid to the container.

The damper preferably includes a seal for sealing a gap between the lid and the container.

The ingredient dropper preferably includes a funnel. Preferably, the funnel is adapted to form a reservoir of the dropper. In other words, the ingredient dropper may include a funnel-shaped reservoir/receptacle. The funnel can promote flow of ingredients from the ingredient dropper the container.

Preferably, a wall of a/the attachment portion forms part of the funnel. Preferably, a wall of the attachment portion also acts as a wall of the funnel. This can facilitate transmission of vibration from the vibration source (to which the attachment portion is directly connected) to the ingredient dropper.

The ingredient dropper preferably includes an aperture for dropping foodstuffs into the container. The aperture is preferably defined through the lid.

The ingredient dropper preferably includes a baffle for baffling a flow of foodstuff between the aperture and the container. The baffle preferably extends across at least part of the aperture. Alternatively or in addition, the aperture of the ingredient dropper is shaped and configured to open into the container in a direction different to a dropping path of food ingredients from the ingredient dropper to the container, preferably by a baffle extending across at least part of the aperture and/or a facing of an opening of the aperture into the container being in a direction different to the dropping direction, and/or wherein at least a part, preferably a major part or all of the aperture is provided in a face of the reservoir which is not the base of the reservoir.

According to another aspect, there is provided an ingredient dropper comprising: an aperture for dropping foodstuff into a container, wherein the aperture is shaped and configured to open into the container in a direction different to a dropping path or direction of foodstuff from the dropper to the container, and/or wherein at least a part of the aperture, and preferably a major part or the whole of the aperture, is provided in a face of the reservoir which is not the base of the reservoir.

This helps reduce the amount of food projected back from where the food is being processed at the end of the dropping path (e.g., the path that the food ingredients dropping into the container would follow under gravity if they dropped straight from the ingredient dropper into the container) back into the aperture.

The aperture can optionally open into the container facing in a direction different to that of the path along which the food ingredients fall from the aperture into the container, preferably closer to orthogonal or opposite to the dropping path. This can help achieve the effect of reducing the amount of material projected back along the flow-path that gets into the aperture, and can be implemented simply by defining a single through-hole in the ingredient dropper or dropper reservoir.

The aperture or dropper may alternatively or in addition have a baffle for baffling a flow of foodstuff between the aperture and the container, wherein the baffle extends across at least part of the aperture, and preferably a major part or the whole of the aperture. This can achieve the effect of reducing food projected back into the aperture by changing the facing of the opening of the aperture into the container and/or by offsetting the flow-path from where it otherwise would have been had the baffle not been present meaning that detritus cannot be projected back along it in a straight line.

The baffle can reduce the amount of detritus being projected from the container to the aperture, and so reduce blockage of the aperture. At the same time, the baffle can promote a steady flow of foodstuff/ingredients from the aperture to the container.

The baffle is preferably adapted for baffling the drop/flow of foodstuff from the aperture into the container. The baffle is preferably (further, or alternatively) adapted for baffling a flow of foodstuff from the container to the aperture.

The ingredient dropper may include a reservoir for foodstuffs, wherein the aperture is defined in the reservoir.

The baffle is preferably spaced apart from the aperture and extends across the entire aperture. This can allow further reducing the blockage of the aperture by detritus from the container.

The ingredient dropper preferably further includes a formation extending from the aperture towards the container. The formation is preferably adapted for guiding a flow of foodstuff from the aperture towards the container.

The baffle preferably forms part of the formation.

The formation preferably includes a first portion including the baffle, and a second portion opposite the first portion. Preferably, the second portion is shorter than the first portion. Preferably, a gap is provided between the first and second portions through which foodstuffs flow/drop into the container.

Preferably, the formation forms part of/is connected to the attachment portion. This can improve the transmission of vibration from the vibration source (to which the attachment portion is directly connected) to the aperture in the ingredient dropper (and to the foodstuffs dropping through the aperture).

The baffle is preferably adapted to direct a flow of foodstuff from the aperture towards a centre of the container and/or away from that portion of the container which is proximate the aperture. This can promote even spreading of the foodstuff throughout the foods in the container, as the foodstuff dropped towards the centre/away from the part proximate the aperture can be spread around the foods in the container by a (e.g. centrifugal) force exerted by a food processing tool in the container.

The baffle is preferably adapted to permit dropping of foodstuffs from the aperture to the container. The baffle is preferably adapted for reducing detritus being projected (from the container) into the aperture whilst allowing foodstuffs to exit the reservoir through the aperture.

The baffle preferably extends at least partly, and more preferably entirely, over the aperture on a side of the aperture opposite to that of the reservoir.

The reservoir is preferably arranged on a periphery of the lid. This can allow the centre of the lid to be used for other purposes, e.g. for receiving a motor unit or providing a feed tube. Preferably, the reservoir extends partially beyond the perimeter of the lid. This can allow providing a larger (and so easier to use) reservoir whilst allowing the use of a smaller lid.

The baffle may be sloped towards the container.

The ingredient dropper may further comprise one or more further baffles for baffling a flow of foodstuff between the aperture and the container. Each baffle may extend across at least part of the aperture. Each baffle may be adapted to direct a flow of foodstuff from the aperture towards the next (typically, lower) baffle. Adjacent baffles may be arranged to face/extend in opposite directions.

According to another aspect, there is provided a lid incorporating the ingredient dropper as aforesaid.

According to another aspect, there is provided a container comprising: the lid as aforesaid, and/or a lid incorporating the ingredient dropper as aforesaid, and/or the ingredient dropper as aforesaid.

The container preferably further comprises a base for supporting the container. The base is preferably adapted to absorb vibration from the container. Preferably, the base is adapted to dampen transmission of vibration from the container to a surface on which the container rests.

The container is preferably adapted for processing a second foodstuff; more preferably wherein the baffle is adapted to restrict flow of the second foodstuff from the container to the aperture. In other words, the baffle is preferably adapted to reduce detritus being projected from the container into the aperture. The baffle is preferably adapted to at least partly occlude the aperture from the second foodstuff in the container.

The container may further comprise a tool for processing foodstuffs in the container. Preferably, the tool is a rotary food processing tool rotatable to perform food processing, more preferably having multiple blades or paddles extending at different angles and/or heights within the container.

The container may be adapted to support the tool, preferably wherein the container includes a bearing point for supporting the tool.

The lid may be adapted to retain the tool, preferably wherein the lid is adapted for suspending the tool therefrom (more preferably, such that the tool does not contact the container).

Preferably, the container further comprises one or more handles, more preferably two handles extending from opposite sides of the container. The handles may extend from an upper lip of the container. The handles may support the lid.

Preferably, the lid and/or container is/are transparent.

According to another aspect, there is provided a food processor device comprising the container as aforesaid, and/or the lid as aforesaid, and/or a lid incorporating the ingredient dropper as aforesaid, and/or the ingredient dropper as aforesaid.

The food processor advice may be a food processing appliance or a kitchen appliance.

According to another aspect, there is provided an ingredient dropper for dropping a first foodstuff into a container, the container being for processing a second foodstuff; the ingredient dropper comprising: an aperture for dropping the first foodstuff into the container, and a baffle for baffling flow of the first and second foodstuffs between the aperture and the container, preferably wherein the baffle extends across at least part of the aperture.

According to another aspect, there is provided a lid for a container, the lid including an ingredient dropper, wherein the lid is adapted to receive drive for driving a tool within the container.

According to another aspect, there is provided a lid for a container, the lid including a receptacle (i.e. reservoir) for foodstuffs, and an aperture in the receptacle for dropping the foodstuffs into the container, wherein the receptacle extends from the lid away from the container.

According to another aspect, there is provided an ingredient dropper comprising an aperture for dropping foodstuffs into a container.

In another aspect of the invention, a lid for the container of a food processing device is disclosed comprising an ingredient dropper, and an attachment point configured to connect directly to a vibration source, which is preferably a drive outlet. Co-locating the attachment point on the dropper and the attachment point on the lid can improve ingredient flow from the ingredient dropper and reduce the chance of blockage due to the transmission of vibrations from the drive outlet to the dropper.

Preferably, the dropper hole of the ingredient dropper is defined through the lid. Transmission of vibrations from the lid directly to the hole can further improve the flow of ingredients.

The ingredient dropper may also preferably comprise a funnel. The funnel reduces the chances of accidental spillage whilst filling the dropper. The funnel may also optionally double as a reservoir/receptacle of the ingredient dropper.

The attachment point optionally comprises a wall, and the wall comprises part of the funnel. This is an efficient design that can reduce material use.

The lid may preferably be configured to support the vibration source (which is preferably a motor). Supporting the vibration source can enhance vibration transmission to the ingredient dropper. This effect is even further enhanced if the lid is configured to support substantially the entire weight of the motor.

The lid may optionally comprise a motor unit with a drive outlet, preferably releasably attachable to the lid. Making the motor unit releasably attachable to the lid means that the lid can be detached from the motor unit for e.g., cleaning. Alternatively the motor unit may be integral to the lid, an arrangement that can simplify manufacturing.

Optionally, the motor unit can further comprise a cable-outlet configured to act as a cable-wrap. This allows efficient storage of the cable.

A container comprising the above-discussed lid is also disclosed. A damper/vibration-dampening means can be located between the lid and the container. This can reduce vibration-transmission from the lid to the container whilst still having the advantage of vibration transmission from the drive-outlet to the ingredient dropper. The vibration-dampening means can include a seal/sealing means for sealing a gap between the lid and the container, and/or an attaching means (i.e. a container attachment portion) for attaching the lid on the container.

The container can optionally include a vibration-absorbing base for supporting the container. This reduces vibrations transmitted from the container to the surface it stands on.

A rotary food processing tool rotatable to perform food processing can be included in the container. Preferably the tool has multiple blades or paddles extending at different angles and/or heights within the container so that it can carry out efficient and effective food processing. The tool may be suspended from the lid, an arrangement which can reduce vibration-transmission to the container. A similar effect can be achieved by supporting the tool on a bearing point of the container.

The container optionally further comprises one or more handles, and preferably two handles extending from opposite sides of the container. This may increase the ease of use of the container. The handles may extend from an upper lip of the container, as this can increase the ease of manufacturing. The handles may optionally support the lid.

The above-described container and/or lid may optionally be transparent. This allows the user to more easily view what is happening through them.

In another aspect of the invention, an ingredient dropper comprising an ingredient reservoir is disclosed with a dropper hole defined in the reservoir, and a baffle extending at least partly, and preferably entirely, over the dropper hole on a side of the dropper hole opposite to that of the reservoir. This reduces detritus being projected into the dropper hole whilst allowing ingredients to exit the reservoir through the dropper hole. A lid comprising this ingredient dropper is disclosed, as is a container comprising this lid, as is a food processor comprising this container.

According to another aspect, there is provided a lid for a container of a food processing device. The lid preferably comprises an ingredient dropper, and an attachment point configured to connect directly to a drive outlet of a motor unit, which preferably acts as a source of vibrations for enhancing ingredient flow from the ingredient dropper.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

The invention extends to methods, systems and apparatus substantially as herein described and/or as illustrated with reference to the accompanying figures.

The invention extends to any novel aspects or features described and/or illustrated herein. Whilst the invention has been described in the field of domestic food processing and preparation appliances, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilizers, grain and other agricultural and/or veterinary products; oils; fuels; dyes; cosmetics; plastics; tars; finishes; waxes; varnishes; beverages; medical and/or biological research materials; solders; alloys; effluent; and/or other substances. Any reference to “food”, “beverage” (or similar language) herein may be replaced by such working mediums.

The invention described here may be used in any appliance, such as a kitchen appliance, and/or as a stand-alone device. This includes any domestic food-processing and/or preparation appliance, including both top-driven appliances (e.g., stand-mixers) and bottom-driven appliances (e.g., food processors). It may be implemented in heated and/or cooled appliances. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered.

“Food” and “foodstuff” as used herein can include solids and liquids, and preferably includes beverages and frozen material and material used in creating them (e.g., coffee beans).

As used herein, the term “processing” preferably connotes any action relating to or contributing towards transforming products into foodstuff, or transforming foodstuff into a different form of foodstuff, including—as examples—applying mechanical work (e.g. for cutting, beating, blending, whisking, dicing, spiralising, grinding, extruding, shaping, kneading etc.) and applying heat or cold. For example, “food processing” as described herein should be taken to encompass chopping, whisking, stirring, kneading, mincing, grinding, shaping, shredding, grating, cooking, freezing, making ice-cream, juicing (centrifugally or with a scroll), or other food-processing activities involving the physical and/or chemical transformation of food and/or beverage material by mechanical, chemical, and/or thermal means. “Food processing attachment” encompasses any attachable component configured, for example on rotation and/or energizing, to carry out any of the previously described food processing tasks.

### BRIEF DESCRIPTION OF DRAWINGS

One or more aspects will now be described, by way of example only and with reference to the accompanying drawings having like-reference numerals, in which:

FIG. 1 shows a perspective drawing of a food processing appliance with an ingredient dropper according to an embodiment of the invention;

FIG. 2 shows a side-on view of the front of the food processing appliance of FIG. 1;

FIG. 3 shows a side-on view of the side of the food processing appliance of FIG. 1;

FIG. 4 shows a side-on cut-away view of the interior of the food processing appliance of FIG. 1; and

FIGS. 5a and 5b show, respectively, perspective views of the top and bottom of an alternative lid for the food processing appliance of FIG. 1.

### SPECIFIC DESCRIPTION

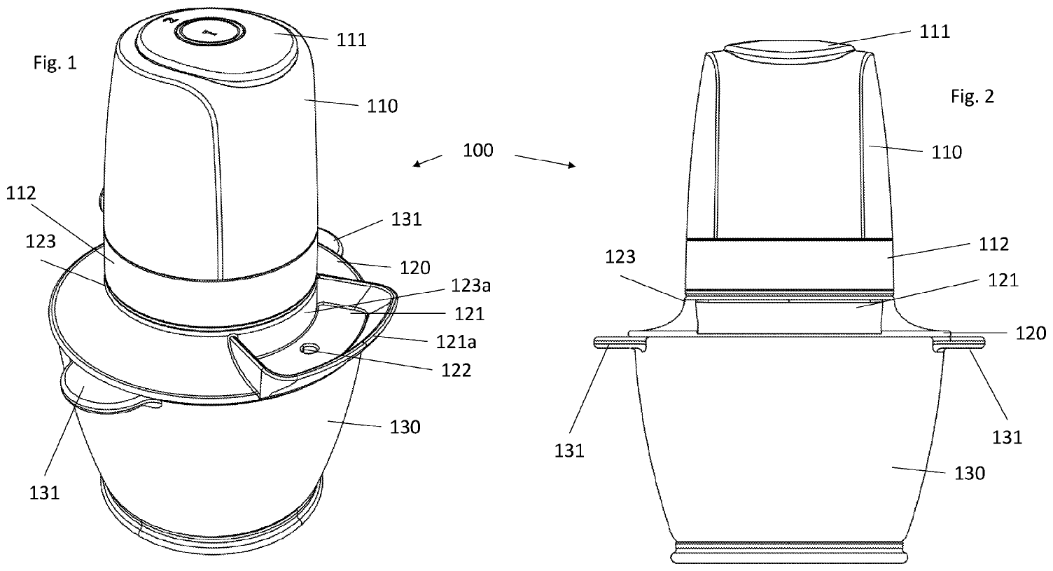

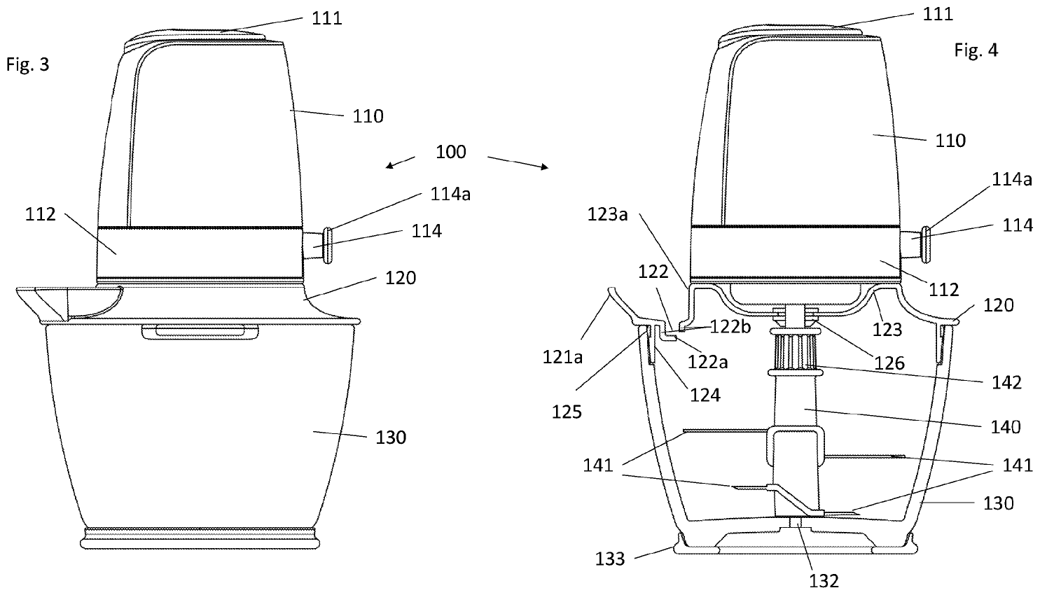

FIGS. 1-4 show a food processing appliance 100 (in this case a top-driven “mini-chopper”-type food processing appliance), comprising a motor unit 110, a lid 120, and a bowl 130. The motor until 110 has a user interface 111 on its upper surface whereby the user can select to operate the motor at a first speed (corresponding to the button marked “1”) or at a second speed (corresponding to the button marked “2” extending concentrically around the button marked “1”). The lower surface of the motor unit 110 (i.e., that on the opposite side of the motor unit 110 to the upper surface) has a drive outlet 112 that can be attached to the lid 120 via a corresponding attachment portion/point 123. The drive outlet is preferably either a protruding drive shaft, or driven-recess connected to a motor of the motor unit 110 to be driven by it. The attachment point 123 can be a niche/recess in the lid into which the drive outlet 112 is latchingly and removably received using e.g., spring-loaded latches. The drive outlet 112 connects to a food processing tool 140 through the lid 120 to drive it.

The lid 120 has an ingredient dropper 121 that comprises a funnel-shaped wall 121a opening at the top, and surrounding an aperture/dropper hole 122 defined extending through the lid 120. Ingredients can thus be quickly placed into the funnel-shaped wall 121a through the relatively wide upper opening, that will slowly drop, dribble, or drizzle through the relatively smaller dropper hole 122 into the bowl 130. The dropper hole 122 preferably has a diameter of 5 mm or less, and more preferably 2 mm or less. The ingredients in the ingredient dropper 121 are thus slowly added to the bowl 130 for, for example, slowly mixing them with other ingredients within the bowl 130 whilst the tool 140 works to mix, whisk, or otherwise work on the contents of the bowl 130. The dropper hole 122 is preferably dimensioned to exclude seeds and pips from the bowl 130, for example it may be smaller than the average lemon-pip.

In a particularly efficient design, the funnel-shaped wall 121a may surround the dropper hole 122 co-operatively with the central hub of the lid 120. For example, as shown in FIG. 1, the funnel-shaped wall 121a can co-operatively surround the dropper hole 122 with an exterior wall 123a of the attachment point 123.

Locating the dropper 121 on the lid 120 together with the attachment point 123 that receives the drive outlet 112 has the advantage that the dropper 121 is directly agitated/vibrated by the drive outlet 112 as it transmits drive impetus to the tool 140. This helps to promote flow of ingredients through the dropper hole 122. In particular, vibration of the dropper 121 causes variations in the pressure of the ingredients flowing through the dropper hole 122, reduces the viscosity of the material within the dropper 121, and acts to shake free pips and other detritus blocked in the dropper hole 122. This effect is enhanced by the motor unit 110 being supported by the lid, and preferably being entirely supported by the lid 120, such that the vibrations of the motor unit 110 are transmitted in large part to the lid 120. To enhance this effect the lid 120 can be made of a relatively stiff, vibration-transmissive material such as a relatively hard plastic (e.g., a relatively hard copolymer such as Tritan™).

To enhance vibration of the dropper 121, the drive outlet 112 is preferably operable to vibrate at a frequency corresponding to a natural frequency of vibration of the dropper 121. For example, the drive outlet 112 may vibrate at a natural frequency of vibration of the dropper 121 when driven at one or more of its operating speeds.

FIG. 4 shows the interior of the bowl 130. In particular it can be seen that a baffle 122a extends either partly or wholly across the dropper hole 122 within the bowl 130. The baffle 122a is spaced axially from the hole 122 such that ingredients can flow into the bowl 130 over it from the dropper hole 122. The baffle 122a therefore acts to reduce the likelihood that food being processed within the bowl 130 will be projected up into the hole 122 to block it. As both the baffle 122a and the co-location of the ingredient dropper 121 on the lid 120 serve to enhance ingredient flow into the container 130 they have a synergistic effect.

As shown in FIG. 4, the baffle 122a forms part of a formation 122b extending from the aperture 122 towards the bowl 130. The formation 122b acts to guide the flow of ingredients from the aperture 122 to the bowl 130. The formation 122b is shorter on the opposite side to the baffle 122a to provide an opening through which the ingredients can flow to the bowl 130.

As can also be seen from FIG. 4 the lid 120 comprises a skirt 124 that extends into and fits within the inner wall of the bowl 130 to locate the lid 120 within the bowl 130 and attach it thereto. The skirt 124 may be made of a vibration-dampening material such as plastic or rubber such that the vibrations transmitted from the lid 120 to the bowl 130 are less severe than those transmitted from the motor unit 110 to the lid 120. The skirt 124 is preferably made of a material that is better at dampening vibration than the lid 120 (and/or the attachment point/portion 123) which, as mentioned, is preferably made of a vibration-transmissive material. For example, the skirt 124 may be made from a relatively soft plastic, and the lid 120 may be made from a relatively hard plastic. To further improve this dampening effect a sealing element 125 may also be located between the lid 120 and the bowl 130 to seal the gap therebetween made of a dampening material such as rubber or plastic. A similarly dampening interface 133 may be formed at the bottom of the bowl such that vibration transmission between the appliance 100 and the surface it stands on is dampened.

The tool 140 connects at one end to the drive outlet 112 of the motor 110 through a sealed bearing 126 of the lid 120. The sealed bearing 126 has a seal, such as, for example, a rubber seal, that prevents food material escaping through the sealed bearing 126. At the other end it bears on a bearing point 132 of the bowl 130, and the weight of the tool 140 may be supported on the bearing point 132 to reduce vibration coupling to the drive outlet 112. Alternatively the tool 140 can be suspended from the lid 120 or drive outlet 112 and not directly contact the bowl 130, again reducing coupling of vibration. The tool 140 can comprise multiple blades/paddles 141 extending at different heights and angles within the bowl 130.

The bowl 130 has one or more handles 131 protruding horizontally from it for making it easier for the user to pick up the bowl 130. The handles 131 are preferably two in number and extend from opposite sides of the bowl 130. For ease of manufacturing, they can be formed as an extension of an upper lip of the bowl 130. The handles 131 may also support the lid 120.

The motor unit 110 can receive mains power for its motor through a cable outlet 114 through which a cable (not shown) extends concentrically. The cable outlet 114 may have a flange 114a formed at the opposite to that which connects to the motor unit 110, such that the cable can be wrapped around it for storage.

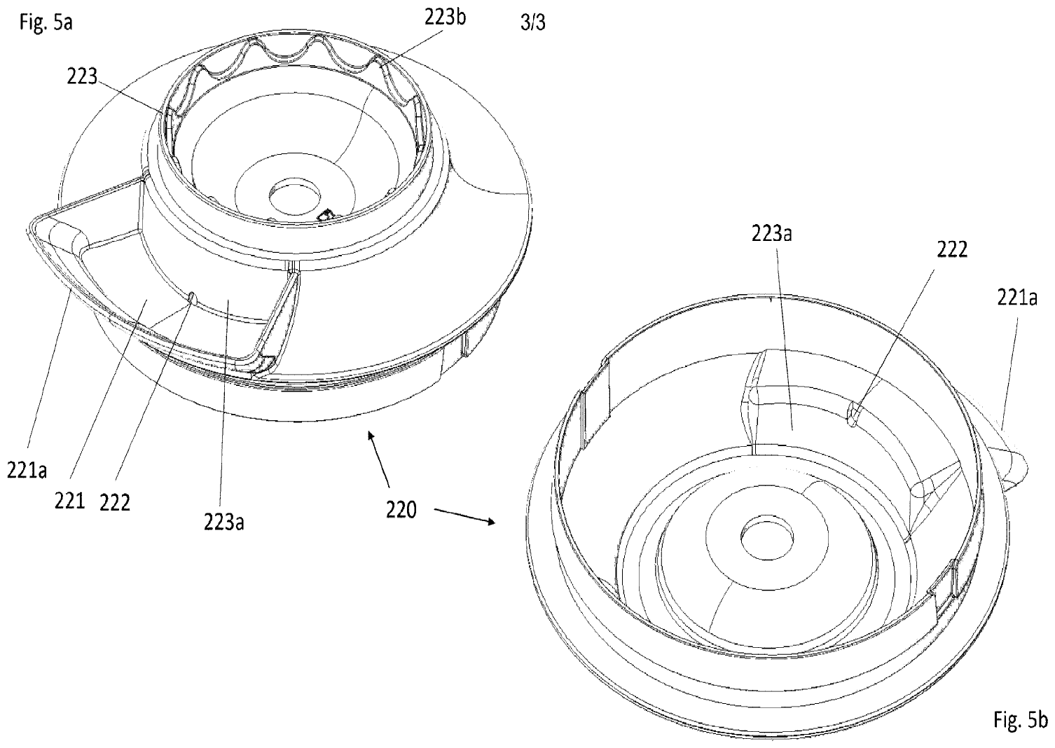

An alternative lid 220 that can be substituted for the lid 120, and is substantially similar to it except as herein described, is shown in FIGS. 5a and 5b. The alternative lid 220 has an ingredient dropper 221 with a dropper hole 222 defined in it through the lid 220.

The lid 220 has an upward-facing attachment portion or point 223 onto which the motor unit 110 can be attached. A gripping formation 223b is provided on an internal surface of the attachment point 223 to help prevent relative rotation of the motor unit 110. The motor unit 110 may have corresponding features designed to correspond or interlock with the gripping formation 223b to enhance this effect.

The dropper hole 222 is defined through the lid 220 communicating between a trough formed on the lid 220, co-operatively by the funnel-shaped wall 221a and an exterior wall 223a of the attachment point 223 or a central hub of the lid such as substantially part-cylindrical wall portion of the lid below the attachment point, and the interior of the bowl 130. In contrast to the dropper hole 121 of the lid 120, the dropper hole 222 of the alternative lid 220 is defined extending mostly through the exterior wall 223a, and opening in use in a substantially horizontal (or at least majorly horizontal) direction into the interior of the container 130, or at least one tangential to the direction that food drops into the container 130. The facing of the opening of the dropper hole 222 into the container 130 in a direction different to that of the path along which food ingredients will drop from the dropper hole 130, and from which processed (or partly processed) food can be projected towards the dropper hole 222 during processing, has the effect, similarly to the baffle 122a, of reducing an area of the inner opening of the dropper hole 222 facing towards where the food is processed. This helps to minimize material from within the bowl 130 being projected upwardly through the hole 222, and can be achieved without restricting an overall diameter of the aperture of the dropper hole 222.

Whilst the hole 222 is shown extending radially-inwardly from the ingredient dropper 221, it could be provided facing outwardly opening towards an inner surface of the downwardly-extending skirt 224 of the lid. In a further alternative the exterior wall 223a may overhang the ingredient dropper 221 and the dropper hole 222 may extend upwardly through it so as to open into the container 130 in a direction opposed to the direction that ingredients ultimately drop into the container 130. The dropper hole 222 is preferably located at or level with a bottom of the ingredient dropper 221 so that all of the material in the ingredient dropper 221 can drain through it under the influence of gravity without having to tilt the lid 220. The dropper hole 222 is preferably defined in a straight line through the ingredient dropper 221 to simplify manufacturing.

The lid 120, bowl 130, and tool 140 are preferably made of dishwasher-safe and food-safe material. Examples of such materials include copolymers such as Tritan™, glass, and stainless steel. The lid 120 and/or the bowl 130 are preferably made of a transparent material so that the user can view the progress of food processing within the appliance 100.

Whilst the appliance 100 has been described herein as a “mini-chopper”, the inventive concepts disclosed here could be applied just as easily to other appliances. For example, the motor unit 110 could be a hand-blender motor-unit. In another example the motor unit 110 may be integral to the lid 120. In another alternative the motor unit 110 is replaced with a stand-mixer, the head-unit of which the lid 120 attaches to and may be supported by it.

Whilst a motor unit 110 has been described above as the source of the vibrations that enhance ingredient flow, other vibration sources could be used with a similar effect, for example, a piezo-electric vibrating element, or sound speaker.

As used herein, the term “removable attachment” (and similar terms such as “removably attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc.). Mechanisms such as a snap-fit, a bayonet attachment, and a hand-rotatable locking nut may be used in this regard.

“Food safe” in this context means any substance that does not shed substances harmful to human health in clinically significant quantities if ingested. For example, it should be BPA-free.

“Dishwasher safe” means that it should be physically and chemically stable during prolonged exposure to the conditions prevailing within a dishwasher machine. For example it should be able to withstand exposure to a mixture of water and a typical dishwasher substance (e.g., washing with Fairy™ or Finish™ dishwasher tablets and water, at temperatures of 82 degrees centigrade for as long as 8 hours without visibly degrading (e.g., cracking)).

It will be understood that the present invention has been described above purely by way of example, and modifications of detail can be made within the scope of the invention.

For example, the baffle 122a may be canted towards the bottom of the bowl 130. This can facilitate dropping of the ingredient into the bowl 130 and reduce the likelihood of the ingredient accumulating on the baffle 122a. The slope of the baffle 122a (relative to the horizontal) is preferably between 10 and 90 degrees, more preferably between 10 and 45 degrees, yet more preferably between 20 and 40 degrees, still more preferably around 30 degrees.

In a further alternative example, the dropper 121 (i.e. the formation 122b) comprises a plurality of baffles 122a arranged to face in alternating directions (i.e. adjacent baffles 122a are arranged to face in opposite directions). This can allow further reducing the likelihood that food being processed within the bowl 130 will be projected up into the hole 122 to block it, as such food would need to travel along a ‘snake’ path defined by the baffles 122a. This can further allow increasing the slope of each baffle 122a towards the container 130 (and so improving the flow of the ingredient to the container 130 and reducing the likelihood of the ingredient accumulating on the baffle 122a) whilst reducing (or at least not increasing) the likelihood that food being processed within the bowl 130 will be projected up into the hole 122 to block it.

Each feature disclosed in the description, and (where appropriate) the claims and drawings may be provided independently or in any appropriate combination.

Reference numerals appearing in the claims are by way of illustration only and shall have no limiting effect on the scope of the claims.

The following lists a number of aspects:
1. A lid for the container of a food processing device comprising an ingredient dropper, and an attachment point configured to connect directly to a vibration source, preferably a drive outlet of a motor unit.
2. The lid of aspect 1, wherein a dropper hole of the ingredient dropper is defined through the lid.
3. The lid of any preceding aspect wherein the ingredient dropper comprises a funnel, preferably wherein the funnel also acts as a reservoir of the dropper.
4. The lid of aspect 3, wherein the attachment point comprises a wall, and the wall comprises part of the funnel.
5. The lid of aspect 1, wherein the lid is configured to support the vibration source, preferably where the vibration source is a motor.
6. The lid of aspect 5, wherein the lid is configured to support substantially the entire weight of the vibration source.
7. The lid of any preceding aspect, further comprising a motor unit with a drive outlet, preferably releasably attachable to the lid or integral to the lid.
8. The lid of aspect 7, wherein the motor unit further comprises a cable-outlet configured to act as a cable-wrap.
9. A container comprising the lid of any preceding aspect.
10. The container of aspect 9, wherein a vibration-dampening means is located between the lid and the container.
11. The container of aspect 10, wherein the vibration-dampening means comprises a sealing means for sealing a gap between the lid and the container.
12. The container of any one of aspects 10-11 where the vibration-dampening means comprises an attaching means for attaching the lid on the container.
13. The container of any one of aspects 9-12, wherein the container comprises a vibration-absorbing base for supporting the container.
14. The container of any one of aspects 9-14, further comprising a rotary food processing tool rotatable to perform food processing, preferably having multiple blades or paddles extending at different angles and/or heights within the container.
15. The container of aspect 14, where the tool is suspended from the lid.
16. The container of aspect 14, wherein the tool is supported on a bearing point of the container.
17. The container of any one of aspects 9-16, wherein the container further comprises one or more handles, and preferably two handles extending from opposite sides of the container.
18. The container of aspect 17, where the handles extend from an upper lip of the container.
19. The container of any one of aspects 17-18, wherein the handles support the lid.
20. The container of any one of aspects 9-19, or lid of any one of aspects 1-8, wherein the lid and/or container is/are transparent.
21. An ingredient dropper comprising an ingredient reservoir, a dropper hole defined in the reservoir, and a baffle extending at least partly, and preferably entirely, over the dropper hole on a side of the dropper hole opposite to that of the reservoir for reducing detritus being projected into the dropper hole whilst allowing ingredients to exit the reservoir through the dropper hole.
22. An ingredient dropper comprising an ingredient reservoir, and a dropper hole defined in the reservoir extending in a direction different to a dropping path, and preferably closer to orthogonal or opposed to the dropping path than to the dropping path.
23. The ingredient dropper of aspect 22 wherein the dropper hole is defined extending in a substantially straight line.
24. A lid comprising the ingredient dropper of any of aspects 21 to 23.
25. A container comprising the lid of aspect 24.
26. A food processor device comprising the container of aspect 25.
27. The lid of any one of aspects 1-8, or container of any one of aspects 9-19, wherein the ingredient dropper is the ingredient dropper of any one of aspects 21 to 23.

1-25. (canceled)

26. A lid for a container, the lid including an ingredient dropper, comprising wherein the lid is adapted to transmit vibration to the ingredient dropper.

27. The lid of claim 26, wherein the lid is adapted to transmit vibration to the ingredient dropper from a vibration source.

28. The lid of claim 27, wherein the lid includes an attachment portion configured to connect directly to the vibration source, and/or wherein the lid is adapted to support at least part of the weight of the vibration source, preferably wherein the lid is adapted to support the entire weight of the vibration source.

29. The lid of claim 27, wherein the vibration source is a motor unit, preferably a motor unit for driving a tool within the container, and/or wherein the lid is adapted to house the vibration source, preferably wherein the vibration source is arranged away from the container.

30. The lid of claim 26, further including a vibration source, preferably wherein the vibration source is releasably attachable to the lid or integral to the lid.

31. The lid of claim 26, wherein the lid is adapted to receive drive for driving a tool within the container.

32. The lid of claim 26, further comprising a damper for dampening transmission of vibration from the lid to the container, optionally wherein the damper includes a container attachment portion, preferably a skirt, for attaching the lid to the container, and/or optionally wherein the damper includes a seal for sealing a gap between the lid and the container.

33. The lid of claim 26, wherein the ingredient dropper includes a funnel, preferably wherein the funnel is adapted to form a reservoir of the dropper and/or wherein a wall of an attachment portion forms part of the funnel.

34. The lid of claim 26, wherein the ingredient dropper includes an aperture for dropping foodstuffs into the container, the aperture being defined through the lid.

35. The lid of claim 34, wherein the ingredient dropper includes a baffle for baffling a flow of foodstuff between the aperture and the container, wherein the baffle extends across at least part of the aperture.

36. An ingredient dropper comprising:
an aperture for dropping foodstuff into a container, and
a baffle for baffling a flow of foodstuff between the aperture and the container, wherein the baffle extends across at least part of the aperture.

37. The ingredient dropper of claim 36, wherein the baffle is spaced apart from the aperture and extends across the entire aperture.

38. The ingredient dropper of claim 36, further including a formation extending from the aperture towards the container, optionally wherein the baffle forms part of the formation.

39. The ingredient dropper of claim 36, wherein the baffle is adapted to direct a flow of foodstuff from the aperture towards a centre of the container and/or away from that portion of the container which is proximate the aperture.

40. A lid incorporating the ingredient dropper of claim 36.

41. A container comprising the lid of claim 26.

42. The container of claim 41, wherein the container further comprises a base for supporting the container, wherein the base is adapted to absorb vibration from the container.

43. The container of claim 41, wherein the container is adapted for processing a second foodstuff; preferably comprising a baffle adapted to restrict flow of the second foodstuff from the container to the aperture.

44. The container of claim 41, further comprising a tool for processing foodstuffs in the container, preferably wherein the tool is a rotary food processing tool rotatable to perform food processing, more preferably having multiple blades or paddles extending at different angles and/or heights within the container; preferably wherein: the container is adapted to support the tool, more preferably wherein the container includes a bearing point for supporting the tool; or the lid is adapted to retain the tool, more preferably wherein the lid is adapted for suspending the tool therefrom.

45. A food processor device comprising the lid of claim 26.
